(19) United States
(12) Patent Application Publication
(10) Pub. No.: US 2019/0013749 A1
(43) Pub. Date: Jan. 10, 2019

(54) Method and Device for Determining a Rotational Speed of an Object

(71) Applicant: STMicroelectronics (Grand Ouest) SAS, Delarue (FR)

(72) Inventor: Michel Catrouillet, Le Mans (FR)

(73) Assignee: STMicroelectronics (Grand Ouest) SAS, Delarue (FR)

(21) Appl. No.: 16/030,661

(22) Filed: Jul. 9, 2018

(30) Foreign Application Priority Data
Jul. 10, 2017 (FR) 1756512

(51) Int. Cl. H02P 6/17; H02K 11/22; G01P 3/40

(52) U.S. Cl. CPC H02P 6/17; G01P 3/40; H02K 11/22

(57) ABSTRACT

In some embodiments, a device for determining a speed of rotation of an object includes a visualization device fastened to the object. A lighting device is configured to light the visualization device by light pulses of adjustable frequency. An adjustment device is configured to adjust a frequency of the light pulses so that the visualization device appears immobile when the object is in rotation. A processor is configured to determine the speed of rotation based on the adjusted frequency.

### CROSS-REFERENCE TO RELATED APPLICATIONS

This application claims priority to French Application No. 1756512, filed on Jul. 10, 2017, which application is hereby incorporated herein by reference.

### TECHNICAL FIELD

Embodiments of the invention relate generally to a device, and in particular embodiments, to a method and device for determining a rotation speed of an object.

### BACKGROUND

Some uses of a motor require the motor to operate at a constant speed of rotation.

In order to ensure that a motor is operating at a speed of rotation that is constant in time, a standard optical checking device may be used, such as represented in FIG. 1. The device of FIG. 1 includes a disc D linked to the shaft A of a motor M and an incandescent lamp L connected to a network R supplying sinusoidal electrical power of known frequency f; for example f is equal to 50 Hz in France or 60 Hz in the United States.

The disc D comprises several tracks P1, P2, etc. as illustrated in FIG. 2, each track P1, P2, etc. comprising optically opaque patterns, respectively M19, M18, M17, etc.

Each of the tracks P1, P2, etc. comprises a different number N of optically opaque patterns arranged on the track alternating with free zones of the disc. The free zones of the disc do not include optically opaque patterns, in other words white zones. The surface area occupied by the optically opaque patterns is equal to the surface area occupied by the free zones of each of the tracks.

The number of optically opaque patterns N of each track depends on the speed of rotation of the motor to be checked and on the frequency f of the network R supplying electrical power to the lamp L, that is to say that a track is gauged for a defined speed of rotation and a known frequency f.

The number of patterns N for a track is equal to two times the frequency f expressed in Hz of the network R supplying power to the incandescent lamp L divided by the assumed speed of rotation w of the motor expressed in revolutions per second, N being an integer number, in the case of the sinusoidal power supply network R.

For example, the track P1 comprises 19 optically opaque patterns M19. If the network R operates at a frequency f of 50 Hz, the track P1 is dimensioned to check a motor operating at 5.26 revolutions per second (rps), i.e. 315.8 rpm. If the network R operates at a frequency f of 60 Hz, the track P1 is dimensioned to check a motor operating at 6.31 rps, i.e. 378.9 rpm.

The disc D comprises 16 tracks, consequently it makes it possible to check only sixteen different speeds of rotation w of the motor M at the frequency f imposed by the electrical power supply network R.

The incandescent lamp L supplied by the network R at the frequency f lights the disc D rotated by the motor M. If the motor M rotates at w revolutions per second, the patterns of the track dimensioned for the speed of rotation w seem to be immobile to the human eye. Otherwise, the patterns are driven by a rotational movement. This phenomenon is known to those skilled in the art as stroboscopic effect.

However, although this test procedure is simple, it does, on the one hand, present the drawback of requiring a different track for each speed of rotation of the motor to be checked for a power supply network with fixed frequency and, on the other hand, depending on the speeds to be checked, the number of optically opaque patterns makes the production of the disc complex.

There is consequently a need to reduce the number of tracks of a rotation speed optical checking disc while making it possible to check a wide spectrum of different speeds of rotation.

### SUMMARY

Some embodiments include a device for determining the speed of an object driven by a rotational movement.

Some embodiments include optical devices for determining the speed of rotation of an object driven by a rotational movement, for example the shaft of an electric motor.

According to one aspect, a method for determining the speed of rotation of an object includes a fastening of a visualization device to the object, a rotating of the object and of the visualization device at the speed of rotation, a lighting of the visualization device by light pulses of adjustable frequency, an adjustment of the frequency so that the visualization device appears immobile, and a determination of the speed of rotation from the value of the duly adjusted frequency.

Contrary to the checking devices known from the prior art, the frequency of the lamp is adjustable, so, for one and the same disc, the range of speeds of rotation that can be checked by the device according to some embodiments is wider than that according to the device known from the prior art.

According to one implementation, the visualization device comprises a disc that includes at least one track comprising a known number of optically opaque patterns, the adjustment of the frequency being performed so that the visualization device appears immobile.

According to another implementation, the determination of the speed of rotation of the object comprises a division of the value of the adjusted frequency by the number of patterns.

According to another aspect, a device is proposed for determining the speed of rotation of an object comprising a visualization device fastened to the object, a lighting device configured to light the visualization device by light pulses of adjustable frequency, an adjustment device configured to adjust the frequency so that the visualization device appears immobile when the object is in rotation, and a processor configured to determine the speed of rotation from the value of the duly adjusted frequency.

In some embodiments, the lighting device comprises, for example, a processing unit configured to drive a stroboscopic lamp and comprising a display device displaying the speed of rotation.

According to one embodiment, the visualization device comprises a disc that includes at least one track comprising several identical optically opaque patterns alternating with free zones such that the surface area occupied by the patterns is equal to the surface area occupied by the free zones.

According to another embodiment, the processor is configured to determine the speed of rotation by dividing the adjusted frequency value by the number of patterns.

Each track is for example configured so as to allow a determination of the value of the speed of rotation within a range of speeds of rotation.

The disc may include, for example, three tracks, a first track comprising two patterns, a second track comprising three patterns, and a third track comprising four patterns, the frequency varying from 40 Hz to 600 Hz.

This exemplary device makes it possible to determine a speed of rotation lying within a range from 600 rpm to 18 000 rpm with only three tracks incorporated in the disc.

In some embodiments, the object includes the shaft of a motor.

### BRIEF DESCRIPTION OF THE DRAWINGS

Other advantages and features of the invention will become apparent on studying the detailed description of non-limiting embodiments, and attached drawings in which:

FIGS. 1 and 2, previously described, illustrate an example of an optical device for determining the speed of rotation of an object driven by a rotational movement according to the prior art; and

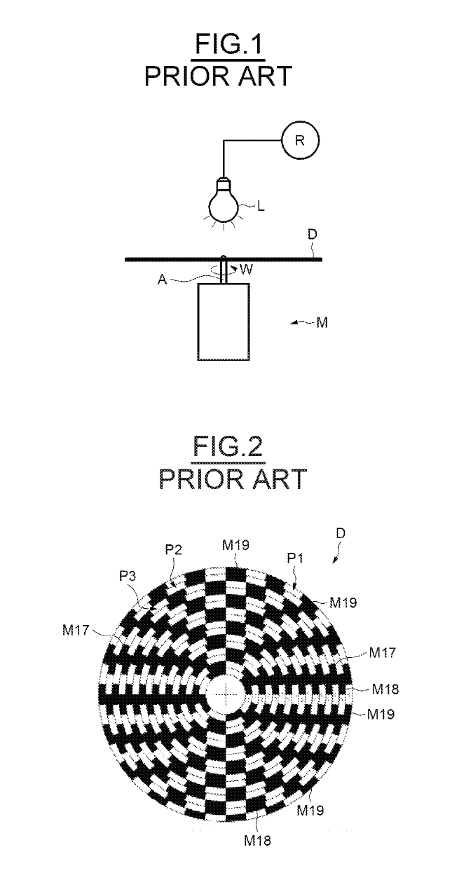

FIGS. 3 and 4 illustrate different embodiments and implementations of the invention.

### DETAILED DESCRIPTION OF ILLUSTRATIVE EMBODIMENTS

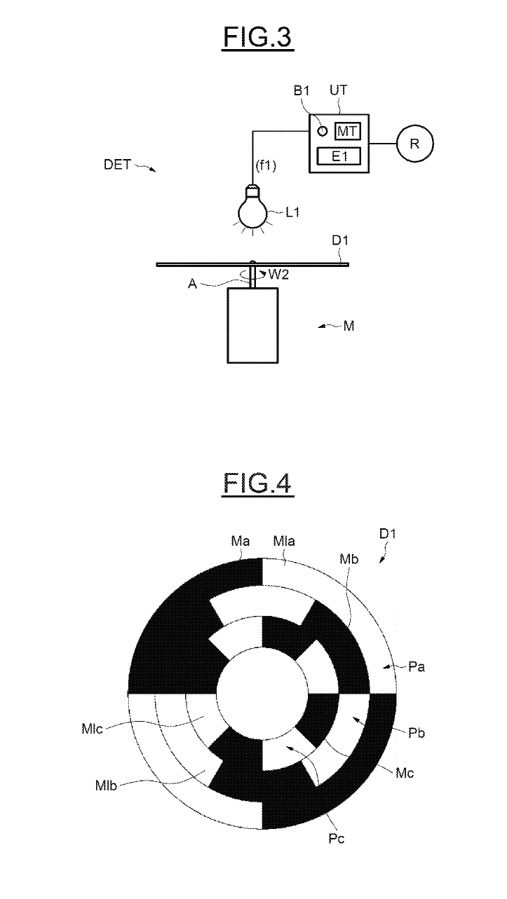

Reference is made to FIG. 3 which represents an exemplary embodiment of an optical device DET for determining the speed of rotation of an object driven by a rotational movement.

The object can, for example, be the shaft A of the motor M.

The device DET comprises the motor M comprising the shaft A described previously. A visualization device comprises a disc D1 fastened to the shaft A of the motor M.

The device DET also comprises a lighting device configured to light the visualization device by light pulses of adjustable frequency f1. The lighting device includes a lamp L1 and a processing unit UT.

The lighting device lights the visualization device when the motor M is operating. For example, the lamp L1 lights, by light pulses of frequency f1, the disc D1 when it is driven by a rotational movement.

In some embodiments, the lamp L1 comprises a stroboscopic lamp known to those skilled in the art. In some embodiments, the stroboscopic lamp is a LED stroboscopic lamp. The lamp L1 is coupled to the processing unit UT. The processing unit UT is coupled to the electrical power supply network R described previously.

The network R supplies power to the lamp L1 via the processing unit UT.

The processing unit UT comprises an adjustment device configured to adjust the frequency f1 of the light pulses so that the visualization device appears immobile when the object is in rotation. This frequency, once adjusted, is denoted f2. The adjustment device comprises, for example, a potentiometer and a display device E1, such as a display screen. As will be seen in more detail herein below, the display device can advantageously directly display the speed of rotation of the object which has been determined, and optionally the value of the frequency f2 which made it possible to obtain the value of the speed of rotation.

The processing unit UT is produced, for example, from a microprocessor, but it can be any device capable of adjusting the frequency f1 of the light pulses of the lamp L1. In some embodiments, the processing unit UT may be a microcontroller.

The device DET further comprises a processor MT which determine the speed of rotation of the object from the value of the frequency of the light pulses f1 so that the visualization device appears immobile and transmits the value of the speed of rotation of the object to the processing unit UT in order for it to be displayed.

The disc D1 comprises P tracks, P being an integer number greater than 1. Each of the tracks comprises a number Nm of optically opaque patterns arranged on the track alternating with free zones of the disc, that is to say zones not including optically opaque patterns, in other words white zones.

The lamp L1 is positioned in relation to the disc D1 such that a human eye clearly distinguishes the optically opaque patterns and the free zones when the disc is lit exclusively by the lamp L1.

The processor MT may include a microprocessor, but they can be any device capable of determining the speed of rotation of the object from the value of the frequency f2 and from the number Nm of patterns. In some embodiments, the processor MT may be a microcontroller or a part of the processing unit UT as represented here.

In one exemplary embodiment of the disc D1, according to FIG. 4, the disc D1 comprises three tracks Pa, Pb and Pc. The track Pa comprises two optically opaque patterns Ma alternating with free zones Mla, the track Pb comprises three optically opaque patterns Mb alternating with free zones Mlb and the track Pc comprises four optically opaque patterns Mc alternating with free zones Mlc; the sum of the surface areas occupied by the optically opaque patterns is equal to the sum of the free zones for each of the tracks Pa, Pb and Pc.

The surface area occupied by the optically opaque patterns is equal to the surface area occupied by the free zones of each of the tracks. The number Nm of patterns is an integer number greater than 2 that is different for each of the tracks incorporated on the disc D1.

A track of the disc D1 associated with the lighting device makes it possible to determine a range of speeds of rotation of the motor M as will be described herein below.

In other words, each track of the disc D1 is configured so as to allow a determination of the value of the speed of rotation within a range of speeds of rotation.

The range of speeds checked by the track concerned is defined by the number Nm of patterns of the track and the value of the frequency f1 of the light pulses.

The number of patterns Nm of the track is equal to the frequency f1 expressed in Hz divided by a speed of rotation w1 of the motor expressed in revolutions per second, rounded to the next higher integer.

Since the frequency f1 is variable, for a number of patterns Nm, a range of speeds of rotation can be determined.

Let f1min be the minimum frequency of the light pulses of the stroboscopic lamp and f1max be the maximum frequency of the light pulses. The range of speeds of rotation of the motor M that can be determined for the number of patterns Nm lies within a range of speeds defined by a lower speed value limit w1min and an upper speed value limit w1max expressed in revolutions per second. The limits w1min and w1max are defined by the following equations:

$$\begin{matrix}w 1 min = \frac{f 1 min}{Nm} & ( 1 ) \\ w 1 max = \frac{f 1 max}{Nm} & ( 2 )\end{matrix}$$

The processing unit UT supplies power to the lamp L1 such that the latter delivers light pulses at the frequency f1 lying within a range defined by the lower limit f1min and the upper limit f1max. For example f1min is equal to 40 Hz and f1max is equal to 600 Hz.

The lamp L1 lights the disc D1 comprising several tracks rotated by the motor M at an unknown speed w2.

In other words, the visualization device fastened to the object are rotated at the speed w2.

Let wc be the target value of the speed of rotation of the motor M.

The target value of the speed of rotation should be understood to be the expected value of the speed of rotation of the motor M.

The disc D1 comprises at least one track comprising an integer number of patterns Nm1 rounded to the next higher integer lying within a range

$$[ \frac{f 1 min}{wc} ; \frac{f 1 max}{wc} ] .$$

The frequency f1 of the light pulses is adjusted so that the visualization device appears immobile, and the speed of rotation w2 is determined from the value of the adjusted frequency.

As indicated above, this frequency value is called f2. The speed of rotation of the motor w2 is equal to f2 divided by Nm1 and is displayed on the screen E1. The speed w2 is equal to we to within a tolerance of one revolution per second.

In other words, the determination of the speed of rotation w2 of the object comprises a division of the value of the adjusted frequency f2 by the number Nm1 of patterns.

If no frequency value f1 lying within the range [f1min; f1max] seems to freeze the optically opaque patterns, the speed of rotation w2 is not included within the range of speeds

$$[ \frac{f 1 min}{Nm 1} ; \frac{f 1 max}{Nm 1} ] .$$

The disc D1 generally comprises several tracks in which the number of optically opaque patterns is defined according to the method explained previously. Each of the tracks of the disc D1 is dimensioned for a range of known speeds of rotation we.

Generally, a value of the frequency f1 renders optically opaque patterns of one or more tracks incorporated in the disc D1 immobile to the human eye. In effect, several tracks can substantially cover one and the same rotation speed value for one and the same frequency value f1 to within a tolerance of one revolution per second. The speed of rotation w2 will thus be able to be determined to within a tolerance of one revolution per second.

In other words, the visualization means comprise a disc comprising at least one track comprising a known number of optically opaque patterns. The adjustment of the frequency f1 is performed so that the visualization device appears immobile.

If the speed w2 does not lie within one of the ranges of speeds of one of the tracks of the disc D1, none of the optically opaque patterns of the disc D1 seems immobile.

According to the exemplary embodiment of the disc D1 according to FIG. 4 described previously, and assuming that the frequency f1 varies for example from 40 Hz to 600 Hz, the track Pa makes it possible to determine a range of speeds of rotation extending from 1200 to 18 000 rpm, the track Pb makes it possible to determine a range of speeds of rotation extending from 800 to 12 000 rpm and the track Pc makes it possible to determine a range of speeds of rotation extending from 600 to 9000 rpm.

Advantageously, with the disc D1 comprising three tracks and a stroboscopic lamp whose light pulse frequency is adjustable from 100 to 200 Hz, a speed of rotation lying between 1500 and 6000 rpm is determined.

Obviously, the invention is not limited to this embodiment. Depending on the speed of rotation of the object, another disc will be able to be chosen.

The determination of speeds of rotation lower than 2000 rpm may entail increasing the number of optically opaque patterns of the track concerned of the disc and reducing the frequency f1, contrary to the determination of speeds of rotation above 600 rpm, which may entail increasing the frequency f1 and reducing the number of patterns of the track concerned of the disc.

For example, to measure a speed of rotation of the object of 200 rpm, the frequency f2 is equal to 40 Hz and the number of patterns of the track concerned is equal to 12, and to measure a speed of rotation of the object of 18 000 rpm, the frequency f2 is equal to 600 Hz and the number of patterns of the track concerned is equal to 2.

What is claimed is:

1. A method for determining a speed of rotation of an object, the method comprising:
fastening a visualization device to the object;
rotating the object and the visualization device at the speed of rotation;
lighting the visualization device by using light pulses of adjustable frequency;
adjusting a frequency of the light pulses so that the visualization device appears immobile; and
determining the speed of rotation based on a value of the adjusted frequency.

2. The method of claim 1, wherein the visualization device comprises a disc that comprises a first track, the first track comprising a number of optically opaque patterns.

3. The method of claim 2, wherein the disc further comprises a second track and a third track, the first track comprising two optically opaque patterns, the second track comprising three optically opaque patterns and the third track comprising four optically opaque patterns, and wherein determining the speed of rotation comprises determining the speed of rotation within a range from 40 Hz to 600 Hz.

4. The method of claim 2, wherein determining the speed of rotation of the object comprises dividing the adjusted frequency by the number of optically opaque patterns.

5. The method of claim 1, wherein the visualization device comprises a disc that comprises a plurality of tracks, each track of the plurality of tracks configured so as to allow a determination of a value of the speed of rotation within a range of speeds of rotation.

6. The method of claim 5, wherein each of the range of speeds of rotation is different.

7. A device for determining a speed of rotation of an object, the device comprising:
a visualization device to be fastened to the object;
a lighting device configured to light the visualization device by light pulses of adjustable frequency;
an adjustment device configured to adjust a frequency of the light pulses so that the visualization device appears immobile when the object is in rotation; and
a processor configured to determine the speed of rotation based on the adjusted frequency.

8. The device of claim 7, wherein the lighting device comprises:
a processing unit configured to drive a stroboscopic lamp; and
a display device configured to display the speed of rotation.

9. The device of claim 7, wherein the visualization device comprises a disc that comprises a first track, the first track comprising a plurality of identical optically opaque patterns alternating with free zones, and wherein a surface area occupied by the plurality of identical optically opaque patterns is equal to a surface area occupied by the free zones.

10. The device of claim 9, wherein the processor is configured to determine the speed of rotation by dividing the adjusted frequency by a number of optically opaque patterns.

11. The device of claim 9, wherein the disc further comprises a second track and a third track, the first track comprising two patterns, the second track comprising three patterns and the third track comprising four patterns, and wherein the first, second and third tracks allow a determination of a value of the speed of rotation within a range from 40 Hz to 600 Hz.

12. The device of claim 7, wherein the visualization device comprises a disc that comprises a plurality of tracks, each track of the plurality of tracks being configured so as to allow a determination of a value of the speed of rotation within a respective range of speeds of rotation.

13. The device of claim 12, wherein each of the respective range of speeds of rotation is different.

14. The device of claim 7, wherein the object comprises a shaft of a motor.

15. The device of claim 7, wherein the processor is coupled to an electrical power supply network.

16. A system comprising:
a motor;
a shaft attached to the motor;
a disc attached to the shaft, the disc comprising a plurality of tracks, each of the plurality of tracks comprising optically opaque patterns alternating with free zones;
a lighting device configured to light the disc using light pulses; and
a processor configured to
adjust a frequency of the light pulses so that a selected track of the plurality of tracks appears immobile to a human eye when the motor is in rotation, and
determine a speed of rotation of the motor based on the adjusted frequency and the selected track.

17. The system of claim 16, wherein the lighting device comprises an LED stroboscopic lamp.

18. The system of claim 16, wherein a surface area occupied by the optically opaque patterns is equal to a surface area occupied by the free zones.

19. The system of claim 16, wherein a first track of the plurality of tracks comprises a first opaque section having a first side and a second side opposite the first side, the first side of the first opaque section being closer to a center of the disc than the second side of the first opaque section;
wherein a second track of the plurality of tracks comprises a second opaque section having a first side, a second side opposite the first side, a third side, and a fourth side opposite the third side, the first side of the second opaque section being closer to the center of the disc than the second side of the second opaque section, the second track being adjacent the first track; and
wherein the second side of the first opaque section is in contact with the first side of the second opaque section continuously from the third side to the fourth side.

20. The system of claim 19, wherein a third side of the second opaque section is aligned with the third side of the first opaque section so as to form a single straight line.
